(19) United States
(12) Patent Application Publication
(10) Pub. No.: US 2015/0197714 A1
(43) Pub. Date: Jul. 16, 2015

(54) Post-Fermentation Beer Style Generation and Distribution Model

(71) Applicant: Greyrock Technology, Inc., Fort Collins, CO (US)

(72) Inventors: Donald M. Bartlett, Fort Collins, CO (US); Andrea M. Bartlett, Miami, FL (US)

(73) Assignee: GREYROCK TECHNOLOGY, INC., Fort Collins, CO (US)

(21) Appl. No.: 14/587,810

(22) Filed: Dec. 31, 2014

Related U.S. Application Data
(60) Provisional application No. 61/927,955, filed on Jan. 15, 2014.

(51) Int. Cl. C12C 11/11

(52) U.S. Cl. CPC C12C 11/11

(57) ABSTRACT

Disclosed are post-fermentation methods for altering a base beer to taste like and have an appearance similar to a target beer, which include analyzing and comparing the beer style characteristics of the target beers and adding style changing ingredients or substances to the base beer. Also disclosed are target beers comprising base beers that have been altered to taste similar to and have an appearance similar to a target beer. Further disclosed are novel distribution methods for a plurality of beer styles using one or few base beer styles.

### CROSS REFERENCE TO RELATED APPLICATIONS

The present application claims the benefit of priority to U.S. Provisional Application No. 61/927,955 filed on Jan. 15, 2014, the contents of which is herein incorporated by reference in its entirety.

### BACKGROUND

There are two primary beer-brewing methods resulting in two main categories of beer, ales and lagers. Within each category, there are numerous beer styles available for consumption. Each style has a different set of characteristics that represent the essence of that particular beer style such as color, mouth feel, bitterness, aroma, and others. In general, these characteristics have a range of acceptable values for a given beer style.

### SUMMARY

An embodiment of the present invention may comprise a post-fermentation method for altering a base beer to taste like and have an appearance similar to a target beer comprising: analyzing a base beer to obtain a plurality of base beer style characteristics; analyzing a target beer to obtain a plurality of target beer style characteristics; comparing said plurality of base beer style characteristics with said plurality of target beer style characteristics to obtain a plurality of difference beer style characteristics; and adding substances to said base beer, post-fermentation, that provide at least a portion of said plurality of difference beer style characteristics so that said base beer has a taste and appearance similar to said target beer.

Another embodiment of the present invention may comprise a method of producing a plurality of styles of beer comprising: obtaining a base beer with a small number of beer style characteristics; and altering said base beer to have a taste and similar appearance to a target beer by: analyzing a base beer to obtain a plurality of base beer style characteristics; analyzing a target beer to obtain a plurality of target beer style characteristics; comparing said plurality of base beer style characteristics with said plurality of target beer style characteristics to obtain a plurality of difference beer style characteristics; and adding substances to said base beer, post-fermentation, that provide at least a portion of said plurality of difference beer style characteristics so that said base beer has a taste and appearance similar to said target beer.

A further embodiment of the present invention may comprise a target beer comprising a base beer that has been altered to taste similar to and have an appearance similar to a target beer, said base beer having a plurality of substances that have been added to said base beer, post-fermentation, so that said base beer has said taste and said appearance similar to said target beer, said substances selected to provide a plurality of difference beer style characteristics that are determined by analyzing said base beer to obtain a plurality of base beer characteristics, analyzing a target beer to obtain a plurality of target beer characteristics, and comparing said plurality of said base beer characteristics with said plurality of target beer characteristics.

### DESCRIPTION OF THE FIGURES

FIG. 1 is a flow diagram showing the current national distribution model for alcohol beverages, in particular, for beer.

FIG. 2 is a flow diagram showing a national distribution model of base beer, beer style changing ingredients, and target beer styles, according to an embodiment of the present invention.

FIG. 3 is a flow diagram showing a local distribution model of base beer, beer style changing ingredients and target beer styles according to an embodiment of the present invention.

FIG. 4 is a flow diagram showing the general process for changing the beer style of a base beer to a target beer style according to an embodiment of the present invention.

### DETAILED DESCRIPTION OF EMBODIMENTS

### I. Changing Beer Styles

The present invention discloses a post-fermentation method of generating one beer style from another beer style by adding, post-fermentation, non-alcoholic, style-changing ingredients to an initial beer to generate a desired-style, target beer. For example, style-changing ingredients could be added to a light lager beer to generate a pale-ale-equivalent-style target beer. A multitude of target beer styles can be generated for a given set of style ingredients based on the choice of the initial beer style. Some target beers will be unique in flavor, taste, color and other beer characteristics that these target beers will be new, unique beer styles not presently available through a traditional brewer. Currently, lagers are consumed at a rate much higher than ales. In the United States, light lagers represent the highest volume of beer sales. Therefore, due to economies of scale, lagers, and in particular, light lagers are the most economically manufactured beer available. Due to lower volumes and lower manufacturing efficiencies, most ale styles of beer cost more to produce and are sold at a higher price than lagers. However, the higher price for ales is not always at a price that results in higher margins for an establishment.

There are a myriad of reasons for the higher lager consumption rates, not just that everyone always prefers a lager. The lower cost and the lower calorie count of light lagers are two often cited reasons for buying this style of lager. If other styles were readily available at a cost comparable to that of widely available lagers, or light lagers, and the calorie content could be managed to be similar to a light lager, many consumers would often times chose another beer style over the lager, or light lager beer styles.

Currently, the only way to have a plurality of beer-style choices at a given establishment is for an establishment to purchase fully-brewed, complete beers, whether ales or lagers, from a beer distributor, to have separate beer taps for each beer style, and to have both room storage and cold storage available for the various kegs (full and empty) of each beer style. Based on the storage capacity of an establishment, there is a limit to the quantity of fully-brewed, complete beers that an establishment can realistically offer for consumption. The ability of an establishment to offer a plurality of beer styles at any given time, economically, without the need for separate beer taps, or without significant space requirements would enhance consumers' experience and provide the establishment with more effective ways of competing for business.

According to an embodiment of the present invention, the target beer style is achieved by analyzing a base beer to obtain a plurality of base beer style characteristics. A target beer is then analyzed to obtain a plurality of base beer style characteristics. The base beer style characteristics and the target beer style characteristics are compared to obtain a plurality of difference beer style characteristics. Substances, or beer-style-changing ingredients, are then added post-fermentation, to the base beer to provide at least a portion of the plurality of difference beer style characteristics so that the base beer has a taste and appearance similar to the target beer. The target beer is impacted by not only the beer-style-changing ingredients, but also the initial beer's characteristics.

Creating a known, target-beer style with a given set of style-changing ingredients requires the initial base beer's characteristics to be known, as previously noted. Thus, the method of altering a base beer with beer-style-changing characteristics can be represented in the following equation: Base Beer A+Style Changing Ingredients=Target Beer B. If a base beer other than a style that is the same as “Beer A” (as per the immediately preceding equation) is used, the target beer may not be of the same style as “Target Beer B” per the preceding equation, but of some other beer style.

Table 1 presents a list of common general beer style characteristics. Not all characteristics are important to all beer styles. Also, there is generally a range of acceptable levels for various characteristics for a given beer style.

TABLE 1

| | | | Units of |
|---|---|---|---|
| Characteristics | | | Measurement |
| Primary | Secondary | Descriptions | (if applicable) |
| Bitterness | | Each beer style has a range of bitterness that | International |
| | | is acceptable, and IPA is considerably more | Bittering Units |
| | | bitter than an American Light Lager | |
| | retention | How long bitterness is retained in the mouth | |
| | | after a beer is swallowed | |
| aroma | | Various ingredients create aromas in beer, | |
| | | some pleasant, others unpleasant. Each beer | |
| | | style has certain aromas that are expected, | |
| | | but not necessarily limited to those aromas | |
| | retention | How long after a drink does the aroma linger | |
| body | | The effective thickness of the beer. Each | |
| | | beer style has a range of expected body properties. | |
| | viscosity | A measure of the body or thickness of the | |
| | | beer, or any liquid. | |
| mouth feel | | The initial, middle of the drink, and end of | |
| | | the drink feel of a beer in the mouth. Each | |
| | | beer style has a range of mouth feels that is | |
| | | generally acceptable. | |
| malt flavor | | A flavor constituent derived from the malt | |
| | | used in the brewing process. Different beer | |
| | | styles have different levels of perceived malt flavor | |
| sweetness | | Perception of sweetness is limited to a few | |
| | | specific sugars | |
| alcohol | | | |
| overall appearance | | | |
| | clarity | A measure of how clear a beer is, free of | |
| | | suspended solids. Similar to turbidity. | |
| | | Different beer styles have different | |
| | | acceptable ranges of clarity. | |
| | color | Each beer style has a range of coloring that | Standard |
| | | is generally acceptable. | Reference Method |
| | turbidity | An indication of how many suspended solids | |
| | | are in a beer. Also associated with clarity. | |
| | | Some beer styles accept more turbidity than others. | |
| foam | | | |
| | CO2 release | Initial over-release of CO2 is considered | |
| | | gushing, an unacceptable aspect for any | |
| | | beer. Some beer styles release more CO2 | |
| | | initially than others. Although this is not | |
| | | generally a qualitative component of beer styles | |
| | Bubble size | Different beer styles can produce different | |
| | | bubble characteristics than others. | |
| | lacing | The remains of the head along the side of a | |
| | | glass after the bubbles have dissipated. | |
| | | Some beer styles generate more lacing than others. | |
| Other Flavors | | | |
| | Special Flavors | Additives or inherent components to beer | |
| | | that create unique flavors for a given beer | |
| | | style. Different beer styles have specific | |
| | | flavor profiles that are expected. | |
| | Special Malts or | Additive malts and adjuncts that create | |
| | adjuncts | specific end flavors in specific beer styles. | |
| | Off flavors | Generally, unwanted aromas and flavors, | |
| | | although an off flavor in one beer style may | |
| | | be more acceptable in another beer style, | |
| | | and in some cases expected for a give beer style. | |
| Finish | | | |
| | crispness | The lack of a lingering taste or mouth | |
| | | feeling after a drink of a beer. Some beer | |
| | | styles are expected to be crisp, while others are not. | |
| | Lingering flavors | The presence of a lingering, or hanging | |
| | | flavor or taste after a drink of beer. Certain | |
| | | beer styles of different lingering flavors and | |
| | | different intensities of lingering flavors | |
| Calories | | A measure of the caloric content of a give | |
| | | beer. Different beer styles have different | |
| | | calorie content, other than for beers | |
| | | considered to be “light” beers, there is no | |
| | | specific expectation of calorie content for a | |
| | | given beer style. | |

In order to convert one beer style to a different beer style, the target beer style will have, in general, more intense characteristics than the initial base beer style. For each of the characteristics shown in Table 1, Table 2 shows the relative change in the characteristic with respect to the initial base beer style. As can be seen from Table 2, some characteristics can be managed nearly independently of the initial beer style and these are indicated in column 2 of Table 2 as “Increasing, Stable or Decreasing”. The word “Stable” in column 2 of Table 2 indicates that the corresponding parameter in column 1 of Table 2 is, or can be maintained, in the target beer style, at the exact level, or nearly the exact level, as in the initial beer style. The word “Increasing” in column 2 of Table 2 indicates that the corresponding parameter in column 1 of Table 2 can be increased in the target beer style. The word “Decreasing” in column 2 of Table 2 indicates that the corresponding parameter in column 1 of Table 2 can be decreased in the target beer style. For some characteristics where “increasing” or “decreasing” may not be sufficiently descriptive, the actual relative change condition is listed in column 2 of Table 2, such as, for “color”, where the target beer style will have a stable or darker color.

TABLE 2

| Characteristics | | Relative Change with respect to |
|---|---|---|
| Primary | Secondary | Initial Beer |
| Bitterness | | Stable or Increasing as measured |
| | | by IBU |
| | retention | Stable or Increasing |
| aroma | | Stable or Increasing |
| | retention | Stable or Increasing |
| body | | Stable or Increasing |
| | viscosity | Stable or Increasing |
| mouth feel | | Stable or Increasing |
| malt flavor | | Stable or Increasing |
| sweetness | | Stable or Increasing |
| alcohol | | Stable |
| overall appearance | | |
| | clarity | Stable or Decreasing |
| | color | Stable or Darker |
| | turbidity | Stable or Increasing |
| foam | | |
| | CO2 release | Increasing, Stable or Decreasing |
| | Bubble size | Increasing, Stable or Decreasing |
| | lacing | Increasing, Stable or Decreasing |
| Other Flavors | | |
| | Special Flavors | Stable or Increasing |
| | Special Malts or adjuncts | Stable or Increasing |
| | Off flavors | Stable or Increasing |
| Finish | | |
| | crispness | Stable or Decreasing |
| | Lingering flavors | Stable or Increasing |
| Calories | | Stable or Increasing |

### II. Key Components and Processes for Generation of a Plurality of Beer Styles

Malted grains are the source of sugars which are fermented into alcohol, and are comprised of for example, barley, rye, oats, millet, etc. that have been malted. Adjunct grains refer to barley, rye, oats, millet, etc. that have not been malted. During the process of mashing, malted grains and adjunct grains are added to heated water. These grains are left to steep in the hot water, allowing enzymes to convert starch and large polysaccharides to the fermentable sugars, glucose and maltose. Once the grains are separated from the mash, this becomes the wort. Grains are separated by filtering through a small mesh strainer, as well as going through the centrifuge to remove any smaller particles and are discarded. Original gravity is the measure of the specific gravity of wort and indicates the amount of fermentable sugars and polysaccharides present in a wort, pre-fermentation. The higher the original gravity, the more sugars and polysaccharides present. This contributes to the sweetness and malt flavor of the beer. It represents the potential wort has to create sweetness and malt characteristics in the final beer.

Different temperatures affect the resulting ratio of large polysaccharides to fermentable sugars because there are two separate enzymes responsible for breaking down starch and its derivatives. Alpha amylase targets alpha-linked, large polysaccharides to yield smaller polysaccharides and has an optimal temperature range of 155-158 degrees Fahrenheit. Beta amylase targets the non-reducing end of polysaccharides to yield only maltose. The optimal temperature range for this enzyme is 140-149 degrees Fahrenheit. Depending on a beer style, a brewer will vary the mash temperature to fall somewhere between these two temperature ranges. With a higher mash temperature, more polysaccharides will be left over after fermentation and this may result in the final beer having a greater mouthfeel. Lower mash temperatures typically result in dry beer with little residual sugar or polysaccharides left over.

Final gravity is the measure of the specific gravity of a beer. Final gravity indicates the amount of residual sugars and polysaccharides present in the beer, post-fermentation. The higher the final gravity, the more residual sugars and saccharides present. Sweeter beer will have a higher gravity. High final gravities can be balanced out by increases in International Bittering Units (“IBU” or “IBUs”). For example, an Imperial IPA has a final gravity range of 1.010-1.020. This is a high final gravity range and if not properly balanced by hops, would result in a sweet beer. However, this beer style also has a high range of IBUs of 60-120. The increased bitterness will balance out with the sweetness. For this product, a greater mouthfeel is desired in order to compensate for the base beer and to achieve the desired new style. Thus, higher mash temperatures are used in order to eliminate and manage the fermentable sugars produced during mashing. Fermentable sugars are deemed undesirable for the purpose of this product because this product is not fermented.

Hops are an important characteristic necessary to achieve the beer style conversion. Hops are the female flower from the hop vine, Humulus lupulus. Hops contain alpha acids that contribute to the IBUs of the final beer. IBUs are a measure of bitterness; the greater the IBUs, the more bitter the beer. A brewer will add hops in varying stages of the brewing process in order to produce hop bitterness, flavor, and aroma. Hops added at the beginning of the boil will add to the bitterness of the final beer. Hops added to the middle of the boil will add hop flavor. Hops added to the end or post-boil, will add to the hop aroma. Hop usage for this product is very similar to the process in the brewhouse. Because of the concentrated nature of this product, more hops are used per gallon of product than you would use in a fully fermented beer, resulting in a very bitter final product. However, when hops are added to a base beer, this addition of hops creates a new style of beer with the correct hop bitterness, flavor, and aroma. Hop particles must also be centrifuged out of the final product to ensure that the consumer is not ingesting these harsh, bitter particles. These are normally filtered out through the process of fermentation, in which the yeast will grab the particles and bring them to the bottom of the fermenter.

Tables 3-9 show the various beer styles and associated characteristics. Information was taken from Beer Judge Certification Program Style Guidelines (2008). In Table 3, column one shows various beer styles; column two shows the category of beer for each beer style; columns three, four, and five show the low, high, and average alcohol by volume content of each beer style, respectively; and columns six, seven, and eight show the low, average, and high of international bittering units of each beer style, respectively. In Table 4, column one shows various beer styles; columns two shows the color description of various beer styles; columns two, three, and four show the low, high, and average original gravity of each beer style, respectively; and columns five, six, and seven show the low, high, and average final gravity of each beer style, respectively. In Table 5, column one shows the various beer styles; columns two, three, and four show the low, high, and average volume of carbon dioxide for each beer style, respectively; and columns six, seven, and eight show the standard reference method for color, respectively. In Table 6, column one shows the various beer styles; column two shows the head retention; column three shows the head color; and column four shows the head description. In Table 7, column one shows the various beer styles; column two shows the body description of the beer style; and column three shows the mouthfeel description of each beer style. In Table 8, column one shows the various beer styles; and column two shows the clarity of each beer style. In Table 9, column one shows the various beer styles; column two shows the carbonation description of each beer style; and column two shows the color description of each beer style.

TABLE 3

| | | | | | International | | |
|---|---|---|---|---|---|---|---|
| | | Alcohol by Volume | | | Bittering Units | | |
| Style | Category | Low | High | Avg | Low | High | Avg |
| Lite American Lager | Light Lager | 2.8 | 4.2 | 3.5 | 8 | 12 | 10 |
| Standard American Lager | Light Lager | 4.2 | 5.3 | 4.75 | 8 | 15 | 11.5 |
| Premium American Lager | Light Lager | 4.6 | 6 | 5.3 | 15 | 25 | 20 |
| Munich Helles | Light Lager | 4.7 | 5.4 | 5.05 | 16 | 22 | 19 |
| Dortmunder Export | Light Lager | 4.8 | 6 | 5.4 | 23 | 30 | 26.5 |
| German Pilsner (Pils) | Pilsner | 4.4 | 5.2 | 4.8 | 25 | 45 | 35 |
| Bohemian Pilsner | Pilsner | 4.2 | 5.4 | 4.8 | 35 | 45 | 40 |
| Classic American Pilsner | Pilsner | 4.5 | 6 | 5.25 | 25 | 40 | 32.5 |
| Vienna Lager | European Amber Lager | 4.5 | 5.5 | 5 | 18 | 30 | 24 |
| Oktoberfest/Märzen | European Amber Lager | 4.8 | 5.7 | 5.25 | 20 | 28 | 24 |
| Dark American Lager | Dark Lager | 4.2 | 6 | 5.1 | 8 | 20 | 14 |
| Munich Dunkel | Dark Lager | 4.5 | 5.6 | 5.05 | 18 | 28 | 23 |
| Schwarzbier (Black Beer) | Dark Lager | 4.4 | 5.4 | 4.9 | 22 | 32 | 27 |
| Maibock/Helles Bock | Bock | 6.3 | 7.4 | 6.85 | 23 | 35 | 29 |
| Traditional Bock | Bock | 6.3 | 7.2 | 6.75 | 20 | 27 | 23.5 |
| Doppelbock | Bock | 7 | 10 | 8.5 | 16 | 26 | 21 |
| Eisbock | Bock | 9 | 14 | 11.5 | 25 | 35 | 30 |
| Cream Ale | Light Hybrid Beer | 4.2 | 5.6 | 4.9 | 15 | 20 | 17.5 |
| Blonde Ale | Light Hybrid Beer | 3.8 | 5.5 | 4.65 | 15 | 28 | 21.5 |
| Kölsch | Light Hybrid Beer | 4.4 | 5.2 | 4.8 | 20 | 30 | 25 |
| American Wheat or Rye | Light Hybrid Beer | 4 | 5.5 | 4.75 | 15 | 30 | 22.5 |
| Beer | | | | | | | |
| Northern German Altbier | Amber Hybrid Beer | 4.5 | 5.2 | 4.85 | 25 | 40 | 32.5 |
| California Common Beer | Amber Hybrid Beer | 4.5 | 5.5 | 5 | 30 | 45 | 37.5 |
| Düsseldorf Altbier | Amber Hybrid Beer | 4.5 | 5.2 | 4.85 | 35 | 50 | 42.5 |
| Standard/Ordinary Bitter | English Pale Ale | 3.2 | 3.8 | 3.5 | 25 | 35 | 30 |
| Special/Best/Premium | English Pale Ale | 3.8 | 4.6 | 4.2 | 25 | 40 | 32.5 |
| Bitter | | | | | | | |
| Extra Special/Strong Bitter | English Pale Ale | 4.6 | 6.2 | 5.4 | 30 | 50 | 40 |
| Scottish Light 60/— | Scottish And Irish Ale | 2.5 | 3.2 | 2.85 | 10 | 20 | 15 |
| Scottish Heavy 70/— | Scottish And Irish Ale | 3.2 | 3.9 | 3.55 | 10 | 25 | 17.5 |
| Scottish Export 80/— | Scottish And Irish Ale | 3.9 | 5 | 4.45 | 15 | 30 | 22.5 |
| Irish Red Ale | Scottish And Irish Ale | 4 | 6 | 5 | 17 | 28 | 22.5 |
| Strong Scotch Ale | Scottish And Irish Ale | 6.5 | 10 | 8.25 | 17 | 35 | 26 |
| American Pale Ale | American Ale | 4.5 | 6 | 5.25 | 30 | 45 | 37.5 |
| American Amber Ale | American Ale | 4.5 | 6 | 5.25 | 25 | 40 | 32.5 |
| American Brown Ale | American Ale | 4.3 | 6.2 | 5.25 | 20 | 40 | 30 |
| Mild | English Brown Ale | 2.8 | 4.5 | 3.65 | 10 | 25 | 17.5 |
| Southern English Brown | English Brown Ale | 2.8 | 4.1 | 3.45 | 12 | 20 | 16 |
| Ale | | | | | | | |
| Northern English Brown | English Brown Ale | 4.2 | 5.4 | 4.8 | 20 | 30 | 25 |
| Ale | | | | | | | |
| Brown Porter | Porter | 4 | 5.4 | 4.7 | 18 | 35 | 26.5 |
| Robust Porter | Porter | 4.8 | 6.5 | 5.65 | 25 | 50 | 37.5 |
| Baltic Porter | Porter | 5.5 | 9.5 | 7.5 | 20 | 40 | 30 |
| Dry Stout | Stout | 4 | 5 | 4.5 | 30 | 45 | 37.5 |
| Sweet Stout | Stout | 4 | 6 | 5 | 20 | 40 | 30 |
| Oatmeal Stout | Stout | 4.2 | 5.9 | 5.05 | 25 | 40 | 32.5 |
| Foreign Extra Stout | Stout | 5.5 | 8 | 6.75 | 30 | 70 | 50 |
| American Stout | Stout | 5 | 7 | 6 | 35 | 75 | 55 |
| Imperial Stout | Stout | 8 | 12 | 10 | 50 | 90 | 70 |
| English IPA | India Pale Ale (IPA) | 5 | 7.5 | 6.25 | 40 | 60 | 50 |
| American IPA | India Pale Ale (IPA) | 5.5 | 7.5 | 6.5 | 40 | 70 | 55 |
| Imperial IPA | India Pale Ale (IPA) | 7.5 | 10 | 8.75 | 60 | 120 | 90 |
| Weizen/Weissbier | German Wheat And | 4.3 | 5.6 | 4.95 | 8 | 15 | 11.5 |
| | Rye | | | | | | |
| Dunkelweizen | German Wheat And | 4.3 | 5.6 | 4.95 | 10 | 18 | 14 |
| | Rye | | | | | | |
| Weizenbock | German Wheat And | 6.5 | 8 | 7.25 | 15 | 30 | 22.5 |
| | Rye | | | | | | |
| Roggenbier (German Rye) | German Wheat And | 4.5 | 6 | 5.25 | 10 | 20 | 15 |
| | Rye | | | | | | |
| Witbier | Belgian And French | 4.5 | 5.5 | 5 | 10 | 20 | 15 |
| | Ale | | | | | | |
| Belgian Pale Ale | Belgian And French | 4.8 | 5.5 | 5.15 | 20 | 30 | 25 |
| | Ale | | | | | | |
| Saison | Belgian And French | 5 | 7 | 6 | 20 | 35 | 27.5 |
| | Ale | | | | | | |
| Bière de Garde | Belgian And French | 6 | 8.5 | 7.25 | 18 | 28 | 23 |
| | Ale | | | | | | |
| Berliner Weisse | Sour Ale | 2.8 | 3.8 | 3.3 | 3 | 8 | 5.5 |
| Flanders Red Ale | Sour Ale | 4.6 | 6.5 | 5.55 | 10 | 25 | 17.5 |
| Flanders Brown Ale/Oud | Sour Ale | 4 | 8 | 6 | 20 | 25 | 22.5 |
| Bruin | | | | | | | |
| Straight (Unblended) | Sour Ale | 5 | 6.5 | 5.75 | 0 | 10 | 5 |
| Lambic | | | | | | | |
| Gueuze | Sour Ale | 5 | 8 | 6.5 | 0 | 10 | 5 |
| Fruit Lambic | Sour Ale | 5 | 7 | 6 | 0 | 10 | 5 |
| Belgian Blond Ale | Belgian Strong Ale | 6 | 7.5 | 6.75 | 15 | 30 | 22.5 |
| Belgian Dubbel | Belgian Strong Ale | 6 | 7.6 | 6.8 | 15 | 25 | 20 |
| Belgian Tripel | Belgian Strong Ale | 7.5 | 9.5 | 8.5 | 20 | 40 | 30 |
| Belgian Golden Strong | Belgian Strong Ale | 7.5 | 10.5 | 9 | 22 | 35 | 28.5 |
| Ale | | | | | | | |
| Belgian Dark Strong Ale | Belgian Strong Ale | 8 | 11 | 9.5 | 20 | 35 | 27.5 |
| Old Ale | Strong Ale | 6 | 9 | 7.5 | 30 | 60 | 45 |
| English Barleywine | Strong Ale | 8 | 12 | 10 | 35 | 70 | 52.5 |
| American Barleywine | Strong Ale | 8 | 12 | 10 | 50 | 120 | 85 |
| Classic Rauchbier | Smoke- | 4.8 | 6 | 5.4 | 20 | 30 | 25 |
| | Flavored/Wood-Aged | | | | | | |

TABLE 4

| | Original Gravity | | | Final Gravity | | |
|---|---|---|---|---|---|---|
| Style | Low | High | Avg | Low | High | Avg |
| Lite American | 1.028 | 1.04 | 1.034 | 0.998 | 1.008 | 1.003 |
| Lager | | | | | | |
| Standard | 1.04 | 1.05 | 1.045 | 1.004 | 1.01 | 1.007 |
| American Lager | | | | | | |
| Premium | 1.046 | 1.056 | 1.051 | 1.008 | 1.012 | 1.01 |
| American Lager | | | | | | |
| Munich Helles | 1.045 | 1.051 | 1.048 | 1.008 | 1.012 | 1.01 |
| Dortmunder | 1.048 | 1.056 | 1.052 | 1.01 | 1.015 | 1.0125 |
| Export | | | | | | |
| German | 1.044 | 1.05 | 1.047 | 1.008 | 1.013 | 1.0105 |
| Pilsner (Pils) | | | | | | |
| Bohemian Pilsner | 1.044 | 1.056 | 1.05 | 1.013 | 1.017 | 1.015 |
| Classic American | 1.044 | 1.06 | 1.052 | 1.01 | 1.015 | 1.0125 |
| Pilsner | | | | | | |
| Vienna Lager | 1.046 | 1.052 | 1.049 | 1.01 | 1.014 | 1.012 |
| Oktoberfest/ | 1.05 | 1.057 | 1.054 | 1.012 | 1.016 | 1.014 |
| Märzen | | | | | | |
| Dark American | 1.044 | 1.056 | 1.05 | 1.008 | 1.012 | 1.01 |
| Lager | | | | | | |
| Munich Dunkel | 1.048 | 1.056 | 1.052 | 1.01 | 1.016 | 1.013 |
| Schwarzbier | 1.046 | 1.052 | 1.049 | 1.01 | 1.016 | 1.013 |
| (Black Beer) | | | | | | |
| Maibock/ | 1.064 | 1.072 | 1.068 | 1.011 | 1.018 | 1.0145 |
| Helles Bock | | | | | | |
| Traditional Bock | 1.064 | 1.072 | 1.068 | 1.013 | 1.019 | 1.016 |
| Doppelbock | 1.072 | 1.112 | 1.092 | 1.016 | 1.024 | 1.02 |
| Eisbock | 1.078 | 1.12 | 1.099 | 1.02 | 1.035 | 1.0275 |
| Cream Ale | 1.042 | 1.055 | 1.049 | 1.006 | 1.012 | 1.009 |
| Blonde Ale | 1.038 | 1.054 | 1.046 | 1.008 | 1.013 | 1.0105 |
| Kölsch | 1.044 | 1.05 | 1.047 | 1.007 | 1.011 | 1.009 |
| American | 1.04 | 1.055 | 1.048 | 1.008 | 1.013 | 1.0105 |
| Wheat or | | | | | | |
| Rye Beer | | | | | | |
| Northern German | 1.046 | 1.054 | 1.05 | 1.01 | 1.015 | 1.0125 |
| Altbier | | | | | | |
| California | 1.048 | 1.054 | 1.051 | 1.011 | 1.014 | 1.0125 |
| Common Beer | | | | | | |
| Düsseldorf Altbier | 1.046 | 1.054 | 1.05 | 1.01 | 1.015 | 1.0125 |
| Standard/ | 1.032 | 1.04 | 1.036 | 1.007 | 1.011 | 1.009 |
| Ordinary Bitter | | | | | | |
| Special/Best/ | 1.04 | 1.048 | 1.044 | 1.008 | 1.012 | 1.01 |
| Premium Bitter | | | | | | |
| Extra Special/ | 1.048 | 1.06 | 1.054 | 1.01 | 1.016 | 1.013 |
| Strong Bitter | | | | | | |
| Scottish | 1.03 | 1.035 | 1.033 | 1.01 | 1.013 | 1.0115 |
| Light 60/— | | | | | | |
| Scottish | 1.035 | 1.04 | 1.038 | 1.01 | 1.015 | 1.0125 |
| Heavy 70/— | | | | | | |
| Scottish | 1.04 | 1.054 | 1.047 | 1.01 | 1.016 | 1.013 |
| Export 80/— | | | | | | |
| Irish Red Ale | 1.044 | 1.06 | 1.052 | 1.01 | 1.014 | 1.012 |
| Strong Scotch Ale | 1.07 | 1.13 | 1.1 | 1.018 | 1.056 | 1.037 |
| American | 1.045 | 1.06 | 1.053 | 1.01 | 1.015 | 1.0125 |
| Pale Ale | | | | | | |
| American | 1.045 | 1.06 | 1.053 | 1.01 | 1.015 | 1.0125 |
| Amber Ale | | | | | | |
| American | 1.045 | 1.06 | 1.053 | 1.01 | 1.016 | 1.013 |
| Brown Ale | | | | | | |
| Mild | 1.03 | 1.038 | 1.034 | 1.008 | 1.013 | 1.0105 |
| Southern English | 1.033 | 1.042 | 1.038 | 1.011 | 1.014 | 1.0125 |
| Brown Ale | | | | | | |
| Northern English | 1.04 | 1.052 | 1.046 | 1.008 | 1.013 | 1.0105 |
| Brown Ale | | | | | | |
| Brown Porter | 1.04 | 1.052 | 1.046 | 1.008 | 1.014 | 1.011 |
| Robust Porter | 1.048 | 1.065 | 1.057 | 1.012 | 1.016 | 1.014 |
| Baltic Porter | 1.06 | 1.09 | 1.075 | 1.016 | 1.024 | 1.02 |
| Dry Stout | 1.036 | 1.05 | 1.043 | 1.007 | 1.011 | 1.009 |
| Sweet Stout | 1.044 | 1.06 | 1.052 | 1.012 | 1.024 | 1.018 |
| Oatmeal Stout | 1.048 | 1.065 | 1.057 | 1.01 | 1.018 | 1.014 |
| Foreign | 1.056 | 1.075 | 1.066 | 1.01 | 1.018 | 1.014 |
| Extra Stout | | | | | | |
| American Stout | 1.05 | 1.075 | 1.063 | 1.01 | 1.022 | 1.016 |
| Imperial Stout | 1.075 | 1.115 | 1.095 | 1.018 | 1.03 | 1.024 |
| English IPA | 1.05 | 1.075 | 1.063 | 1.01 | 1.018 | 1.014 |
| American IPA | 1.056 | 1.075 | 1.066 | 1.01 | 1.018 | 1.014 |
| Imperial IPA | 1.075 | 1.09 | 1.083 | 1.01 | 1.02 | 1.015 |
| Weizen/Weissbier | 1.044 | 1.052 | 1.048 | 1.01 | 1.014 | 1.012 |
| Dunkelweizen | 1.044 | 1.056 | 1.05 | 1.01 | 1.014 | 1.012 |
| Weizenbock | 1.064 | 1.09 | 1.077 | 1.015 | 1.022 | 1.0185 |
| Roggenbier | 1.046 | 1.056 | 1.051 | 1.01 | 1.014 | 1.012 |
| (German Rye) | | | | | | |
| Witbier | 1.044 | 1.052 | 1.048 | 1.008 | 1.012 | 1.01 |
| Belgian Pale Ale | 1.048 | 1.054 | 1.051 | 1.01 | 1.014 | 1.012 |
| Saison | 1.048 | 1.065 | 1.057 | 1.002 | 1.012 | 1.007 |
| Bière de Garde | 1.06 | 1.08 | 1.07 | 1.008 | 1.016 | 1.012 |
| Berliner Weisse | 1.028 | 1.032 | 1.03 | 1.003 | 1.006 | 1.0045 |
| Flanders Red Ale | 1.048 | 1.057 | 1.053 | 1.002 | 1.012 | 1.007 |
| Flanders Brown | 1.04 | 1.074 | 1.057 | 1.008 | 1.012 | 1.01 |
| Ale/Oud Bruin | | | | | | |
| Straight | 1.04 | 1.054 | 1.047 | 1.001 | 1.01 | 1.0055 |
| (Unblended) | | | | | | |
| Lambic | | | | | | |
| Gueuze | 1.04 | 1.06 | 1.05 | 1 | 1.006 | 1.003 |
| Fruit Lambic | 1.04 | 1.06 | 1.05 | 1 | 1.01 | 1.005 |
| Belgian Blond Ale | 1.062 | 1.075 | 1.069 | 1.008 | 1.018 | 1.013 |
| Belgian Dubbel | 1.062 | 1.075 | 1.069 | 1.008 | 1.018 | 1.013 |
| Belgian Tripel | 1.075 | 1.085 | 1.08 | 1.008 | 1.014 | 1.011 |
| Belgian Golden | 1.07 | 1.095 | 1.083 | 1.005 | 1.016 | 1.0105 |
| Strong Ale | | | | | | |
| Belgian Dark | 1.075 | 1.11 | 1.093 | 1.01 | 1.024 | 1.017 |
| Strong Ale | | | | | | |
| Old Ale | 1.06 | 1.09 | 1.075 | 1.015 | 1.022 | 1.0185 |
| English | 1.08 | 1.12 | 1.1 | 1.018 | 1.03 | 1.024 |
| Barleywine | | | | | | |
| American | 1.08 | 1.12 | 1.1 | 1.016 | 1.03 | 1.023 |
| Barleywine | | | | | | |
| Classic Rauchbier | 1.05 | 1.057 | 1.054 | 1.012 | 1.016 | 1.014 |

TABLE 5

| | | | | Standard Reference Method | | |
|---|---|---|---|---|---|---|
| | Volume of CO₂ | | | for Color | | |
| Style | Low | High | Avg | Low | High | Avg |
| Lite American Lager | 2.50 | 2.80 | 2.65 | 2 | 3 | 2.5 |
| Standard American | 2.50 | 2.80 | 2.65 | 2 | 4 | 3 |
| Lager | | | | | | |
| Premium American | 2.50 | 2.80 | 2.65 | 2 | 6 | 4 |
| Lager | | | | | | |
| Munich Helles | 2.30 | 2.70 | 2.50 | 3 | 5 | 4 |
| Dortmunder Export | 2.40 | 2.70 | 2.55 | 4 | 6 | 5 |
| German Pilsner (Pils) | 2.40 | 2.80 | 2.60 | 2 | 5 | 3.5 |
| Bohemian Pilsner | 2.30 | 2.60 | 2.45 | 3.5 | 6 | 4.75 |
| Classic American | 2.50 | 2.70 | 2.60 | 3 | 6 | 4.5 |
| Pilsner | | | | | | |
| Vienna Lager | 2.40 | 2.60 | 2.50 | 10 | 16 | 13 |
| Oktoberfest/Märzen | 2.50 | 2.80 | 2.65 | 7 | 14 | 10.5 |
| Dark American Lager | 2.50 | 2.90 | 2.70 | 14 | 22 | 18 |
| Munich Dunkel | 2.20 | 2.70 | 2.45 | 14 | 28 | 21 |
| Schwarzbier (Black | 2.20 | 2.70 | 2.45 | 17 | 30 | 23.5 |
| Beer) | | | | | | |
| Maibock/Helles Bock | 2.20 | 2.70 | 2.45 | 6 | 11 | 8.5 |
| Traditional Bock | 2.20 | 2.70 | 2.45 | 14 | 22 | 18 |
| Doppelbock | 2.30 | 2.60 | 2.45 | 6 | 25 | 15.5 |
| Eisbock | 2.20 | 2.60 | 2.40 | 18 | 30 | 24 |
| Cream Ale | 2.60 | 2.70 | 2.65 | 2.5 | 5 | 3.75 |
| Blonde Ale | 2.40 | 2.80 | 2.60 | 3 | 6 | 4.5 |
| Kölsch | 2.40 | 2.80 | 2.60 | 3.5 | 5 | 4.25 |
| American Wheat or | 2.30 | 2.60 | 2.45 | 3 | 6 | 4.5 |
| Rye Beer | | | | | | |
| Northern German | 2.16 | 3.09 | 2.63 | 13 | 19 | 16 |
| Altbier | | | | | | |
| California Common | 2.40 | 2.80 | 2.60 | 10 | 14 | 12 |
| Beer | | | | | | |
| Düsseldorf Altbier | 2.10 | 3.10 | 2.60 | 11 | 17 | 14 |
| Standard/Ordinary | 0.80 | 2.20 | 1.50 | 4 | 14 | 9 |
| Bitter | | | | | | |
| Special/Best/Premium | 0.80 | 2.10 | 1.45 | 5 | 16 | 10.5 |
| Bitter | | | | | | |
| Extra Special/Strong | 1.50 | 2.40 | 1.95 | 6 | 18 | 12 |
| Bitter | | | | | | |
| Scottish Light 60/— | 1.50 | 2.30 | 1.90 | 9 | 17 | 13 |
| Scottish Heavy 70/— | 1.50 | 2.30 | 1.90 | 9 | 17 | 13 |
| Scottish Export 80/— | 1.50 | 2.30 | 1.90 | 9 | 17 | 13 |
| Irish Red Ale | 2.10 | 2.60 | 2.35 | 9 | 18 | 13.5 |
| Strong Scotch Ale | 1.60 | 2.40 | 2.00 | 14 | 25 | 19.5 |
| American Pale Ale | 2.26 | 2.78 | 2.52 | 5 | 14 | 9.5 |
| American Amber Ale | 2.26 | 2.78 | 2.52 | 10 | 17 | 13.5 |
| American Brown Ale | 2.00 | 2.60 | 2.30 | 18 | 35 | 26.5 |
| Mild | 1.30 | 2.30 | 1.80 | 12 | 25 | 18.5 |
| Southern English | 1.30 | 2.30 | 1.80 | 19 | 35 | 27 |
| Brown Ale | | | | | | |
| Northern English | 2.20 | 2.70 | 2.45 | 12 | 22 | 17 |
| Brown Ale | | | | | | |
| Brown Porter | 1.80 | 2.50 | 2.15 | 20 | 30 | 25 |
| Robust Porter | 1.80 | 2.50 | 2.15 | 22 | 35 | 28.5 |
| Baltic Porter | 2.30 | 2.80 | 2.55 | 17 | 30 | 23.5 |
| Dry Stout | 1.60 | 2.00 | 1.80 | 25 | 40 | 32.5 |
| Sweet Stout | 2.00 | 2.40 | 2.20 | 30 | 40 | 35 |
| Oatmeal Stout | 1.90 | 2.50 | 2.20 | 22 | 40 | 31 |
| Foreign Extra Stout | 2.00 | 2.60 | 2.30 | 30 | 40 | 35 |
| American Stout | 2.30 | 2.90 | 2.60 | 30 | 40 | 35 |
| Imperial Stout | 1.80 | 2.60 | 2.20 | 30 | 40 | 35 |
| English IPA | 2.20 | 2.70 | 2.45 | 8 | 14 | 11 |
| American IPA | 2.20 | 2.70 | 2.45 | 6 | 15 | 10.5 |
| Imperial IPA | 2.20 | 2.70 | 2.45 | 8 | 15 | 11.5 |
| Weizen/Weissbier | 2.50 | 2.90 | 2.70 | 2 | 8 | 5 |
| Dunkelweizen | 2.50 | 2.90 | 2.70 | 14 | 23 | 18.5 |
| Weizenbock | 2.40 | 2.90 | 2.65 | 12 | 25 | 18.5 |
| Roggenbier (German | 2.50 | 2.90 | 2.70 | 14 | 19 | 16.5 |
| Rye) | | | | | | |
| Witbier | 2.10 | 2.60 | 2.35 | 2 | 4 | 3 |
| Belgian Pale Ale | 2.10 | 2.70 | 2.40 | 8 | 14 | 11 |
| Saison | 2.30 | 2.90 | 2.60 | 5 | 14 | 9.5 |
| Bière de Garde | 2.30 | 2.90 | 2.60 | 6 | 19 | 12.5 |
| Berliner Weisse | 2.40 | 2.90 | 2.65 | 2 | 3 | 2.5 |
| Flanders Red Ale | 2.20 | 2.70 | 2.45 | 10 | 16 | 13 |
| Flanders Brown | 2.20 | 2.80 | 2.50 | 15 | 22 | 18.5 |
| Ale/Oud Bruin | | | | | | |
| Straight (Unblended) | 1.80 | 2.60 | 2.20 | 3 | 7 | 5 |
| Lambic | | | | | | |
| Gueuze | 2.40 | 3.10 | 2.75 | 3 | 7 | 5 |
| Fruit Lambic | 2.40 | 3.10 | 2.75 | 3 | 7 | 5 |
| Belgian Blond Ale | 2.20 | 2.80 | 2.50 | 4 | 7 | 5.5 |
| Belgian Dubbel | 2.30 | 2.90 | 2.60 | 10 | 17 | 13.5 |
| Belgian Tripel | 2.40 | 3.00 | 2.70 | 4.5 | 7 | 5.75 |
| Belgian Golden | | | | | | |
| Strong Ale | 2.30 | 2.90 | 2.60 | 3 | 6 | 4.5 |
| Belgian Dark Strong | 2.30 | 2.90 | 2.60 | 12 | 22 | 17 |
| Ale | | | | | | |
| Old Ale | 1.80 | 2.50 | 2.15 | 10 | 22 | 16 |
| English Barleywine | 1.60 | 2.50 | 2.05 | 8 | 22 | 15 |
| American Barleywine | 1.80 | 2.50 | 2.15 | 10 | 19 | 14.5 |
| Classic Rauchbier | 2.40 | 2.80 | 2.60 | 12 | 22 | 17 |

TABLE 6

| Style | Head Retention | Head Color | Head Description |
|---|---|---|---|
| Lite American Lager | none | white | frothy |
| Standard American Lager | none | white | frothy |
| Premium American Lager | none | white | frothy |
| Munich Helles | low | white | creamy |
| Dortmunder Export | persistent | white | creamy |
| German Pilsner (Pils) | long-lasting | white | creamy |
| Bohemian Pilsner | long-lasting | white | dense, creamy |
| Classic American Pilsner | long-lasting | white | substantial |
| Vienna Lager | persistent | off-white | large |
| Oktoberfest/Märzen | persistent | off-white | solid |
| Dark American Lager | not lasting | light tan | frothy |
| Munich Dunkel | | light-med tan | creamy |
| Schwarzbier (Black Beer) | persistent | tan | large |
| Maibock/Helles Bock | persistent | white | large, creamy |
| Traditional Bock | persistent | off-white | large, creamy |
| Doppelbock | persistent, less so with | white to off-white | large, creamy |
| | increased strength | | |
| Eisbock | persistent, less so with | off-white to deep | pronounced legs |
| | increased strength | ivory | |
| Cream Ale | fair | white | low to medium |
| Blonde Ale | fair to good | white | low to medium |
| Kölsch | may no persist | white | delicate |
| American Wheat or Rye Beer | long-lasting | white | big |
| Northern German Altbier | good | white to off-white | low to medium |
| California Common Beer | good | off-white | moderate |
| Düsseldorf Altbier | long-lasting | off-white | thick, creamy |
| Standard/Ordinary Bitter | little due to low CO2 | white to off-white | low to medium |
| Special/Best/Premium Bitter | little due to low CO2 | white to off-white | low to medium |
| Extra Special/Strong Bitter | little due to low CO2 | white to off-white | low to medium |
| Scottish Light 60/- | low to moderate | off-white to light tan | creamy |
| Scottish Heavy 70/- | low to moderate | off-white to light tan | creamy |
| Scottish Export 80/- | low to moderate | off-white to light tan | creamy |
| Irish Red Ale | low | off-white to tan | |
| Strong Scotch Ale | may not persist | tan | large, legs |
| American Pale Ale | good | white to off-white | moderately large |
| American Amber Ale | good | off-white | moderately large |
| American Brown Ale | low | off-white to light tan | low to medium |
| Mild | may be poor | off-white to tan | low to medium |
| Southern English Brown Ale | low | off-white to tan | low to medium |
| Northern English Brown Ale | low | off-white to tan | low to medium |
| Brown Porter | fair to good | off-white to light tan | moderate |
| Robust Porter | moderately good | tan | full |
| Baltic Porter | persistent | tan | thick |
| Dry Stout | long-lasting | tan to brown | thick, creamy |
| Sweet Stout | persistent | tan to brown | creamy |
| Oatmeal Stout | persistent | tan to brown | thick, creamy |
| Foreign Extra Stout | good | tan to brown | large |
| American Stout | persistent | light tan to light brown | large |
| Imperial Stout | low to moderate | deep tan to dark brown | well-formed, legs |
| English IPA | persistent | off-white | good head stand |
| American IPA | persistent | off-white | good head stand |
| Imperial IPA | persistent | off-white | good head stand |
| Weizen/Weissbier | long-lasting | white | thick, moussey |
| Dunkelweizen | long-lasting | off-white | thick, moussey |
| Weizenbock | long-lasting | tan | thick, moussey |
| Roggenbier (German Rye) | persistent | off-white to tan | large, thick, creamy, rocky |
| Witbier | good | white | dense, moussey |
| Belgian Pale Ale | low | white | creamy, rocky |
| Saison | long-lasting | white to ivory | dense, rocky, lacing |
| Bière de Garde | good | white to off-white | well-formed |
| Berliner Weisse | poor | white | large, dense |
| Flanders Red Ale | average to good | white to light tan | |
| Flanders Brown Ale/Oud Bruin | average to good | ivory to light tan | |
| Straight (Unblended) Lambic | poor | white | effervescent |
| Gueuze | excellent, last forever | white | thick, rocky, moussey |
| Fruit Lambic | long-lasting | fruit-colored | thick, rocky, moussey |
| Belgian Blond Ale | good | white to off-white | large, dense, creamy, lace |
| Belgian Dubbel | long-lasting | off-white | large, dense, creamy |
| Belgian Tripel | long-lasting | white | cream, rocky, lace |
| Belgian Golden Strong Ale | long-lasting | white | massive, rocky, beady, lace |
| Belgian Dark Strong Ale | persistent | cream to light tan | massive, dense, moussey |
| Old Ale | low | cream to light tan | low to medium |
| English Barleywine | low | off-white | low to medium, legs |
| American Barleywine | low | off-white to light tan | moderately low to large, legs |
| Classic Rauchbier | persistent | cream to tan | large, creamy, rich |

TABLE 7

| Style | Body | Mouthfeel |
|---|---|---|
| Lite American Lager | very light | carbonic bite |
| Standard American Lager | very light | carbonic bite |
| Premium American Lager | medium-light | carbonic bite |
| Munich Helles | medium | smooth malt |
| Dortmunder Export | medium | crisp |
| German Pilsner (Pils) | medium-light | light |
| Bohemian Pilsner | medium to medium-full | heavier than German due to soft water |
| Classic American Pilsner | medium | rich, creamy |
| Vienna Lager | medium-light to medium | creamy, smooth, crisp finish, bit alcohol warming |
| Oktoberfest/Märzen | medium | creamy, smooth |
| Dark American Lager | light to medium | smooth |
| Munich Dunkel | medium to medium-full | firm, dextrinous, maybe astringent, alcohol |
| Schwarzbier (Black Beer) | medium-light to medium | smooth |
| Maibock/Helles Bock | medium | smooth, alcohol warm, |
| Traditional Bock | medium to medium-full | smooth, alcohol warm, |
| Doppelbock | medium-full to full | very smooth |
| Eisbock | full to very full | alcohol warmth, very smooth |
| Cream Ale | light to medium | thirst-quenching finish (high attenuated), alcohol, crisp |
| Blonde Ale | medium-light to medium | smooth |
| Kölsch | medium-light | smooth, crisp, well attenuated |
| American Wheat or Rye Beer | medium-light to medium | alcohol |
| Northern German Altbier | medium-light to medium | smooth |
| California Common Beer | medium | creamy |
| Düsseldorf Altbier | medium | smooth |
| Standard/Ordinary Bitter | light to medium- light | |
| Special/Best/Premium Bitter | medium-light to medium | |
| Extra Special/Strong Bitter | medium-light to medium-full | slight alcohol |
| Scottish Light 60/- | medium-low to medium | creamy or quite dry |
| Scottish Heavy 70/- | medium-low to medium | creamy or quite dry |
| Scottish Export 80/- | medium-low to medium | creamy or quite dry |
| Irish Red Ale | medium-light to medium | smooth, may have slick, alcohol |
| Strong Scotch Ale | medium-full to full | thick, chewy, smooth, alcoholic |
| American Pale Ale | medium-light to medium | smooth finish |
| American Amber Ale | medium to medium-full | smooth finish, alcohol |
| American Brown Ale | medium to medium-full | dry, resiny, alcohol |
| Mild | light to medium | light astringency for roast, full for |
| Southern English Brown Ale | medium | sweeter creamy, smooth, may feel heavier |
| Northern English Brown Ale | medium-light to medium | |
| Brown Porter | medium-light to medium | |
| Robust Porter | medium to medium-full | alcohol, slight astringency |
| Baltic Porter | full | smooth, alcohol warm, |
| Dry Stout | medium-light to medium-full | smooth, slight astringency |
| Sweet Stout | medium-full to full | |
| Oatmeal Stout | medium-full to full | smooth, silky, slick, creamy |
| Foreign Extra Stout | medium-full to full | smooth, creamy, alcohol warm |
| American Stout | medium to full | creamy, astringency, alcohol warm |
| Imperial Stout | full to very full | chewy, velvety, alcohol warm |
| English IPA | medium-light to medium | smooth, alcohol warm, |
| American IPA | medium-light to medium | smooth, alcohol warm, |
| Imperial IPA | medium-light to medium | dry, alcohol warm |
| Weizen/Weissbier | medium-light to medium | fluffy, creamy to spritzy finish |
| Dunkelweizen | medium-light to medium-full | fluffy, creamy, light finish |
| Weizenbock | medium-full to full | creamy, alcohol |
| Roggenbier (German Rye) | medium to medium-full | may have light tartness |
| Witbier | medium-light to medium | smooth, creamy, finishes dry |
| Belgian Pale Ale | medium-light to medium | |
| Saison | light to medium | prickly acidity, dry finish, alcohol |
| Bière de Garde | medium-light to medium light | warm, smooth, silky, alcohol |
| Berliner Weisse | | dry finish |
| Flanders Red Ale | medium | astringency, acidity, light and crisp, sweet finish |
| Flanders Brown Ale/Oud Bruin | medium to medium-full | sweet and tart finish |
| Straight (Unblended) Lambic | light to medium-light | dry, tart, astringency, alcohol |
| Gueuze | light to medium-light | dry, tart, astringency |
| Fruit Lambic | light to medium-light | dry, tart, astringency |
| Belgian Blond Ale | medium | smooth, creamy, alcohol warm, bubbly |
| Belgian Dubbel | medium-full | smooth, alcohol warm, |
| Belgian Tripel | medium-light to medium | creamy |
| Belgian Golden Strong Ale | light to medium | smooth, alcohol warm, |
| Belgian Dark Strong Ale | medium-light to full | smooth |
| Old Ale | medium to full | chewy, alcohol |
| English Barleywine | full | chewy, velvety, alcohol warm |
| American Barleywine | full | chewy, velvety, alcohol warm |
| Classic Rauchbier | medium | smooth |

TABLE 8

| Style | Clarity |
|---|---|
| Lite American Lager | very clear |
| Standard American Lager | very clear |
| Premium American Lager | very clear |
| Munich Helles | clear |
| Dortmunder Export | clear |
| German Pilsner (Pils) | very clear |
| Bohemian Pilsner | very clear |
| Classic American Pilsner | bright |
| Vienna Lager | bright |
| Oktoberfest/Märzen | bright |
| Dark American Lager | bright |
| Munich Dunkel | usually clear, can be murky unfiltered |
| Schwarzbier (Black Beer) | very clear |
| Maibock/Helles Bock | clear |
| Traditional Bock | clear |
| Doppelbock | clear |
| Eisbock | clear |
| Cream Ale | brilliant |
| Blonde Ale | clear to brilliant |
| Kölsch | filtered clear |
| American Wheat or Rye Beer | brilliant to hazy |
| Northern German Altbier | very clear |
| California Common Beer | clear |
| Düsseldorf Altbier | brilliant |
| Standard/Ordinary Bitter | brilliant to good |
| Special/Best/Premium Bitter | brilliant to good |
| Extra Special/Strong Bitter | brilliant to good |
| Scottish Light 60/- | very clear |
| Scottish Heavy 70/- | very clear |
| Scottish Export 80/- | very clear |
| Irish Red Ale | clear |
| Strong Scotch Ale | clear |
| American Pale Ale | clear to slightly hazy |
| American Amber Ale | clear to slightly hazy |
| American Brown Ale | clear |
| Mild | clear |
| Southern English Brown Ale | clear |
| Northern English Brown Ale | clear |
| Brown Porter | clear |
| Robust Porter | clear |
| Baltic Porter | clear |
| Dry Stout | clear |
| Sweet Stout | clear |
| Oatmeal Stout | clear |
| Foreign Extra Stout | clear |
| American Stout | opaque |
| Imperial Stout | opaque |
| English IPA | clear to slightly hazy |
| American IPA | clear to slightly hazy |
| Imperial IPA | clear to slightly hazy |
| Weizen/Weissbier | hazy |
| Dunkelweizen | hazy |
| Weizenbock | hazy |
| Roggenbier (German Rye) | hazy, cloudy |
| Witbier | very cloudy |
| Belgian Pale Ale | clear |
| Saison | poor to good with no haze |
| Bière de Garde | poor to good with no haze |
| Berliner Weisse | clear to hazy |
| Flanders Red Ale | clear |
| Flanders Brown Ale/Oud Bruin | clear |
| Straight (Unblended) Lambic | clear to hazy |
| Gueuze | very clear unless shaken |
| Fruit Lambic | clear |
| Belgian Blond Ale | very clear |
| Belgian Dubbel | clear |
| Belgian Tripel | clear |
| Belgian Golden Strong Ale | clear |
| Belgian Dark Strong Ale | clear to hazy |
| Old Ale | clear |
| English Barley wine | good to brilliant, chill haze |
| American Barleywine | good to brilliant, chill haze |
| Classic Rauchbier | very clear |

TABLE 9

| Style | Carbonation | Color Description |
|---|---|---|
| Lite American Lager | high | very pale straw to pale yellow |
| Standard American Lager | high | very pale straw to medium yellow |
| Premium American Lager | high | pale straw to gold |
| Munich Helles | medium | medium yellow to pale gold |
| Dortmunder Export | medium | light gold to deep gold |
| German Pilsner (Pils) | medium to high | straw to light gold |
| Bohemian Pilsner | medium | very pale gold to deep burnished gold |
| Classic American Pilsner | medium to high | yellow to deep gold |
| Vienna Lager | medium | light reddish amber to copper |
| Oktoberfest/Märzen | medium | dark gold to deep orange-red |
| Dark American Lager | high | deep amber to dark brown |
| Munich Dunkel | medium | deep copper to dark brown (red-garnet tint) |
| Schwarzbier (Black Beer) | medium to medium-high | medium to very dark brown |
| Maibock/Helles Bock | medium to medium-high | deep gold to light amber |
| Traditional Bock | medium-low to medium | light copper to brown (garnet highlights) |
| Doppelbock | medium-low to medium | deep gold to dark brown (darker: red highlights) |
| Eisbock | low | deep copper to dark brown (red-garnet tint) |
| Cream Ale | high | pale straw to gold |
| Blonde Ale | medium to high | light yellow to deep gold |
| Kölsch | medium to medium-high | very pale gold to light gold |
| American Wheat or Rye Beer | medium-high to high | very pale yellow to gold |
| Northern German Altbier | medium to medium-high | light copper to light brown |
| California Common Beer | medium to medium-high | medium amber to light copper |
| Düsseldorf Altbier | medium to medium-high | light amber to orange-bronze to deep copper |
| Standard/Ordinary Bitter | low to medium | light yellow to light copper |
| Special/Best/Premium Bitter | low to medium | medium gold to medium copper |
| Extra Special/Strong Bitter | low to medium | gold to deep copper |
| Scottish Light 60/- | low to medium | deep amber to dark copper |
| Scottish Heavy 70/- | low to medium | deep amber to dark copper |
| Scottish Export 80/- | low to medium | deep amber to dark copper |
| Irish Red Ale | medium | deep amber to deep reddish copper |
| Strong Scotch Ale | medium | light copper to dark brown |
| American Pale Ale | medium to high | pale gold to deep amber |
| American Amber Ale | medium to high | amber to coppery brown |
| American Brown Ale | medium to medium-high | light brown to very dark brown |
| Mild | low to medium-low | copper to dark brown or mahogany |
| Southern English Brown Ale | low to medium-low | light brown to very dark brown |
| Northern English Brown Ale | medium to medium-high | dark amber to reddish brown |
| Brown Porter | medium-low to medium-high | light brown to dark brown (red highlights) |
| Robust Porter | medium-low to medium-high | medium brown to very dark brown (red-garnet highlights) |
| Baltic Porter | medium to medium-high | dark reddish copper to opaque dark brown |
| Dry Stout | low to medium | deep brown (garnet highlights) to jet black |
| Sweet Stout | low to medium | very dark brown to black (can be opaque) |
| Oatmeal Stout | medium to medium-high | medium brown to black (can be opaque) |
| Foreign Extra Stout | medium to medium-high | very deep brown to black (can be opaque) |
| American Stout | medium-high to high | very dark brown to jet black (usually opaque) |
| Imperial Stout | low to medium | very dark reddish brown to jet black (opaque) |
| English IPA | medium to medium-high | golden amber to light copper |
| American IPA | medium to medium-high | medium gold to medium reddish copper |
| Imperial IPA | medium to medium-high | golden amber to medium reddish copper |
| Weizen/Weissbier | high | pale straw to very dark gold |
| Dunkelweizen | medium to high | light copper to mahogany brown |
| Weizenbock | medium to high | dark amber to dark reddish brown |
| Roggenbier (German Rye) | high | light coppery orange to dark reddish or coppery brown |
| Witbier | high | very pale straw to very light gold |
| Belgian Pale Ale | medium | amber to copper |
| Saison | very high | gold to pale orange to amber |
| Bière de Garde | medium to high | gold to reddish bronze to chestnut brown |
| Berliner Weisse | very high | very pale straw |
| Flanders Red Ale | low to medium | deep red burgundy to reddish brown |
| Flanders Brown Ale/Oud Bruin | light to medium | dark reddish brown to brown |
| Straight (Unblended) Lambic | completely to virtually none | pale yellow to deep gold |
| Gueuze | high | gold |
| Fruit Lambic | high | variety of fruit usually determines |
| Belgian Blond Ale | medium-high to high | light gold to deep gold |
| Belgian Dubbel | medium-high | dark amber to copper |
| Belgian Tripel | high | deep yellow to deep gold |
| Belgian Golden Strong Ale | very high | yellow to medium gold |
| Belgian Dark Strong Ale | high | deep amber to deep coppery brown |
| Old Ale | low to medium | light amber to very dark reddish brown |
| English Barleywine | low to medium | deep gold to very dark amber to very dark brown |
| American Barleywine | low to medium | light amber to medium copper to light brown |
| Classic Rauchbier | medium to medium-high | medium amber to light copper to dark brown |

### III. Examples

### Example 1

### Equation for Creating a Batch of Beer-Style-Changing Characteristics

By using the method described herein, every 1 gallon brewed of style changing ingredients (or collectively referred to as “substances”) will result in 128 doses of product able to be added to a base beer. For example, 1 gallon of beer style changing ingredients or substances, is assumed to be produced. In order to determine the amount of hops to add to the boil, some simple equations are utilized. Let “x” be the desired IBUs for the target beer and “y” equal the IBUs of the base beer (i.e., the original non-flavored, post-fermentation beer without style changing ingredients).

x−y=z

Here, “z” equals the amount of IBU that the beer style changing ingredients must increase the base beer. Assuming a 12 ounce base beer, 1 ounce style changer, and 1 gallon boil volume, the number of IBUs that must be present in the boil (IBU) can be determined. “Ounce” herein, may be abbreviated as “oz.” and “gallon” may be abbreviated as “gal.”

(12 oz.+1 oz.)×z=IBU

To finally calculate the ounces of hops needed from the IBU, we need the volume of the boil (V), the utilization factor (U), which is well-known in the art, (note boil time and OG are needed), and the conversion factor to convert IBU unit ml/L to oz/gal.

$$AAU = W \times \% AA = \frac{IBU \times V}{74.89 \times U}$$

$$W = \frac{IBU \times V}{74.89 \times U \times \% AA}$$

A similar calculation must be made for the desired final gravity of the target beer style. Average values for final gravities are listed in Table 4. Using the difference between the two styles (base beer and target beer), the amount of grain may be calculated. Let the subscripts T, B, and S represent the target beer, base beer, and style changing ingredients, respectively.

FG_{T}−FG_{B}=OG_{S}

Next, the OG needs to be converted from 0.0XX to XX. Now, the points towards SG contributed from each grain may be found. Let “x” and “y” symbolize different grain types. P is potential points for extract, W is weight of the grain, PPG is the potential of the malt to yield extract, available from the malt house, and E is the efficiency of the brewhouse.

$${OG}_{S} = {p}_{x} + {p}_{y} + … = \frac{{W}_{x} \times {PPG}_{x} \times E}{V} + \frac{{W}_{y} \times {PPG}_{y} \times E}{V} + …$$

After adding all the grains together, the starting gravity of a desired base can be determined. The product is then diluted due to this starting gravity contributing to the 1:12 ratio of 1 ounce of product to 12 ounces of beer.

$${FG}_{T} = \frac{{SG}_{s}}{13}$$

### Example 2

### Changing the Beer Style of a Base Beer to Create a Target Beer

The following is an example of a post-fermentation method and composition for creating a new beer style by changing the beer style of a base beer to create a target beer. As previously noted, there are two general categories of beer styles, lagers and ales. Within these two general categories, one skilled in the art can recognize that there are other beer styles of lagers and ales, including but not limited to, Pale lager, Witbier, Pilsner, Berliner Weisse, Maibock, Blonde Ale, Weissbier, American Pale Ale, India Pale Ale, Weisbier Saison, English Bitter, Biere de Garde, Double IPA, Dark lager, Vienna lager, Marzen, Amber ale, Brown ale, Bock, Dunkel, Dunkelweizen, Irish Dry Stout, Doppelbock, Porter, Stout, Foreign Stout, Baltic Porter, and Imperial Stout. The composition for creating this target styled beer may be comprised of the following style changing ingredients: an effective amount of style changing ingredients, or substances, such as carbohydrate, such as malt or starch, water, and aged hops. The style changing ingredients can be in the form of a liquid, powder, semi-solid, or a solid. An effective amount, as used herein, is one or more style changing ingredients or substances added to the base beer in order to create a target beer. When used, the one or more style changing ingredients are present in an effective amount. The effective amount of style changing ingredients used in the base beer is that amount that imparts the desired property or properties in the target beer. It is undesirable to include an amount of style changing ingredients in excess of the effective amount. One skilled in the art can use or include other types of carbohydrates. Malts can include, but are not limited to, lager malts, pale ale malts, wheat malts, and rye malts; kilned malts such as Biscuit, Victory, Munich, Vienna, and Dextrin; caramel malts such as Caramel 10, Caramel 20, Caramel 40, Caramel 80, Caramel 120, and Special B; and roasted malts, such as Chocolate malt, Black Patent malt, and Roasted Barley. One skilled in the art can use a variety of hops, including but not limited to, Admiral, Ahtanum, Amarillo, Apollo, Bramling Cross, Brewer's Gold, Bullion, Cascade, Centennial, Challenger, Chinook, Citra®, Cluster, Columbus, Comet, Crystal, Eroica, El Dorado, First Gold, Feux-Coeur Francais, Fuggles, Galaxy, Galena, Glacier, Goldings, Green Bullet, Greenburg, Hallertau/Hallertauer Mittelfriih, Herald, Herkules, Hersbrucker, Horizon, Liberty, Lublin, Magnum, Merkur, Millennium, Motueka, Mosaic, Mount Hood, Mount Rainier, Nelson Sauvin, Newport, Northdown, Northern Brewer, Nugget, Opal, Pacifica, Pacific Gem, Pacific Jade, Palisade, Perle, Phoenix, Pilgrim, Pilot, Pioneer, Polnischer Lublin, Pride of Ringwood, Progress, Riwaka, Saaz, San Juan Ruby Red, Santiam, Saphir, Satus, Select, Simcoe, Smaragd, Sorachi Ace, Sonnet Golding, Southern Cross, Spalt, Sterling, Strisselspalt, Styrian Aurora, Styrian Bobek, Styrian Goldings, Styrian Celeia, Summit, Super Galena, Tardif de Bourgogne, Target, Taurus, Tettnang, Tillicum, Tomahawk, Tradition, Ultra, Vanguard, Waimea, Warrior, Whitbread Golding Variety (WGV), Willamette, Zeus, and Zythos.

Quantities of ingredients will vary depending on the batch size. Each batch size can be calculated based on the number of doses desired for a given batch. A standard dose for adding the style changing composition, or substances, to a base beer beverage post-fermentation is 1 ounce. Therefore, if a batch size of 3 gallons is wanted, the following will calculate the number of one ounce doses for making three gallons.

$$y = ( \frac{3 gallons}{1 ounce} ) ( \frac{128 ounces}{1 gallon} ) = 384 ounces$$

An example method for creating a target beer from a base beer is as follows. Start with a base beer having a particular beer style. The base beer can be any one of the styles of lagers and ales, including but not limited to, Pale or light lager, Witbier, Pilsner, Berliner Weisse, Maibock, Blonde Ale, Weissbier, American Pale Ale, India Pale Ale, Weisbier Saison, English Bitter, Biere de Garde, Double IPA, Dark lager, Vienna lager, Marzen, Amber ale, Brown ale, Bock, Dunkel, Dunkelweizen, Irish Dry Stout, Doppelbock, Porter, Stout, Foreign Stout, Baltic Porter, and Imperial Stout. However, it is preferable to start with a lighter beer (i.e., pale or light lager). The base beer is analyzed to obtain a plurality of base beer style characteristics, such as those characteristics listed in Table 1. The next step is to decide which target beer style is desired. Once the target beer style is selected, it must be analyzed for a plurality of characteristics such as international bitterness units, aroma, body, mouth-feel, malt flavor, sweetness, flavor, calories, clarity, turbidity, and crispness, or any other characteristics as mentioned in Table 1. The plurality of base beer style characteristics are compared with the plurality of target beer style characteristics to obtain a plurality of difference beer style characteristics. Beer-style-changing ingredients or substances are added to the base beer, post-fermentation, to provide at least a portion of the plurality of beer style characteristics so that the base beer has a taste and appearance similar to the target beer.

### Example 3

### Changing the Beer Style of a Pale Ale or a Light Lager to Create a Medium-Bodied Style Beer

The following is an example of a post-fermentation method and composition for creating a new beer style by changing the beer style of a base beer, such as a pale ale or light lager, to create a target beer, such as a medium-bodied style beer. As previously noted, there are two general categories of beer styles, lagers and ales. Within these two general categories, one skilled in the art can recognize that there are other beer styles of lagers and ales, including but not limited to, Pale lager, Witbier, Pilsner, Berliner Weisse, Maibock, Blonde Ale, Weissbier, American Pale Ale, India Pale Ale, Weisbier Saison, English Bitter, Biere de Garde, Double IPA, Dark lager, Vienna lager, Marzen, Amber ale, Brown ale, Bock, Dunkel, Dunkelweizen, Irish Dry Stout, Doppelbock, Porter, Stout, Foreign Stout, Baltic Porter, and Imperial Stout. The composition for creating this new styled beer may be comprised of the following style changing ingredients: an effective amount of one or more beer-style-changing characteristics or substances such as carbohydrate, such as malt or starch, water, and aged hops. The style changing ingredients can be in the form of a liquid, powder, semi-solid, or a solid. An effective amount, as used herein, is one or more style changing ingredients added to the base beer in order to create a target beer. When used, the one or more style changing ingredients are present in an effective amount. The effective amount of style changing ingredients used in the base beer is that amount that imparts the desired property or properties in the target beer. It is undesirable to include an amount of style changing ingredients in excess of the effective amount. One skilled in the art can use or include other types of carbohydrates. Malts can include, but are not limited to, lager malts, pale ale malts, wheat malts, and rye malts; kilned malts such as Biscuit, Victory, Munich, Vienna, and Dextrin; caramel malts such as Caramel 10, Caramel 20, Caramel 40, Caramel 80, Caramel 120, and Special B; and roasted malts, such as Chocolate malt, Black Patent malt, and Roasted Barley. One skilled in the art can use a variety of hops, including but not limited to, Admiral, Ahtanum, Amarillo, Apollo, Bramling Cross, Brewer's Gold, Bullion, Cascade, Centennial, Challenger, Chinook, Citra®, Cluster, Columbus, Comet, Crystal, Eroica, El Dorado, First Gold, Feux-Coeur Francais, Fuggles, Galaxy, Galena, Glacier, Goldings, Green Bullet, Greenburg, Hallertau/Hallertauer Mittelfriih, Herald, Herkules, Hersbrucker, Horizon, Liberty, Lublin, Magnum, Merkur, Millennium, Motueka, Mosaic, Mount Hood, Mount Rainier, Nelson Sauvin, Newport, Northdown, Northern Brewer, Nugget, Opal, Pacifica, Pacific Gem, Pacific Jade, Palisade, Perle, Phoenix, Pilgrim, Pilot, Pioneer, Polnischer Lublin, Pride of Ringwood, Progress, Riwaka, Saaz, San Juan Ruby Red, Santiam, Saphir, Satus, Select, Simcoe, Smaragd, Sorachi Ace, Sonnet Golding, Southern Cross, Spalt, Sterling, Strisselspalt, Styrian Aurora, Styrian Bobek, Styrian Goldings, Styrian Celeia, Summit, Super Galena, Tardif de Bourgogne, Target, Taurus, Tettnang, Tillicum, Tomahawk, Tradition, Ultra, Vanguard, Waimea, Warrior, Whitbread Golding Variety (WGV), Willamette, Zeus, and Zythos.

Quantities of ingredients will vary depending on the batch size. Each batch size can be calculated based on the number of doses desired for a given batch. A standard dose for adding the style changing composition to a base beer beverage post-fermentation is 1 ounce. Therefore, if a batch size of 3 gallons is wanted, the following calculate the number of one ounce doses for making three gallons.

$$y = ( \frac{3 gallons}{1 ounce} ) ( \frac{128 ounces}{1 gallon} ) = 384 ounces$$

An example method for creating a medium-bodied style target beer from a light lager or light ale base beer is as follows. Start with a base beer, such as a light lager or a pale ale, which has a particular beer style. The beer style characteristics for the base beer, a light lager or pale ale, can be found in Tables 3-7. The next step is to decide which target beer style is desired. In this example, the target beer style is a medium-bodied ale. The medium-bodied ale is analyzed for its characteristics such as good head retention, moderately large head, white to off-white head color, clear to slightly hazy color, medium-light to medium body, and smooth mouthfeel, characteristics which can be found in Tables 3-7. Once the beer style characteristics are determined for both the base and target beers, the plurality of beer style characteristics of the base beer are compared with the plurality of beer style characteristics of the target beer to obtain a plurality of difference beer style characteristics. Style changing ingredients or substances are then added to the base beer, post-fermentation, to provide at least a portion of the plurality of difference beer style characteristics so that the base beer, the light lager or pale ale, have a taste and appearance similar to the target beer, a medium-bodied ale. The style changing ingredients or substances include an effective amount of Dark Munich malt, Black Patent malt, flaked barley, aged hops, and water. To begin the process for making a batch of the style changing ingredients or substances, use a mill such as the gain mill, mill the malt to crack open the malt. Weigh out the flaked barley but keep it separate from the malt. The style changing ingredients are mashed, which is a process that is well-known in the art. Please see for example, “The Brewing of Beer: Mashing and Sparging” by Moritz, Edward R., Hazen Press, February 2011.

The product needs to run though a centrifuge to ensure smaller, unwanted particles are eliminated (unwanted particles produce bitter off-flavors in the final product). This product is now called the wort.

Next, place the wort into a boil kettle. Bring the wort up to a boil and add in the hops. Maintain this boil for about 30 minutes. Strain the contents of the boil kettle through a strainer to remove more particulate matter. A finer strainer may additionally be used to remove any finer unwanted particles. The product needs to run though a centrifuge again to ensure smaller, unwanted particles are eliminated.

Return the product back to the boil kettle. Bring the contents up to pasteurization temperature. Before packaging, the pH of the mixture must be determined. The pH must be below 4.3 in order for the mixture to be ready for packaging. If it is above 4.3, add acid in ⅛ teaspoon increments until desired pH is achieved. The product is now ready to be packaged. An acid blend has been used in this case. This blend contains malic and tartaric acid.

The product can be packaged in one ounce doses, for example. For example, packaging has been done using a home vacuum sealer and a straight sealer. Product is packaged cold. Other packaging possibilities may include: packaging the final product immediately after it is finished, putting the sealed packages into a water bath that reaches 185 degrees Fahrenheit, sterilizing packaging and product immediately before filling, or a combination of these.

Canning, such as in glass jars, has also been used as a method of preservation and methods associated therewith are well-known in the art. Other types of packaging may include bottling in twelve ounce beer bottles. In a twelve ounce bottle, there are twelve doses of product available. Flavor stability of the product is seen weeks after bottling. Flavor and aroma of the new beer style can be stabilized by for example, the use of vacuum sealing. Further, other types of packing for the final composition of beer style changing ingredients or substances may also be packaged, for example, in pods. The style changing composition or substances, may also be packaged in bulk containers, such as kegs, barrels, totes, or other large types of containers. Other types of industry appropriate packaging for the final composition of beer style changing ingredients or substances may be used and is well-known in the art.

The final composition of style-changing ingredients or substances can now be added to the base beer, a light lager or a pale ale, post-fermentation, to provide at least a portion of the plurality of difference beer style characteristics so that the base beer has a taste and appearance similar to the target beer, a medium-bodied ale.

### Example 4

### Changing the Beer Style of a Pale Ale or a Light Lager to Create a Stout

The following is an example of a post-fermentation method and composition for creating a new style of beer by changing the beer style of a base beer, such as a pale ale or a light lager, to create a target beer, such as a stout. As previously noted, there are two general categories of beer styles, lagers and ales. Within these two general categories, one skilled in the art can recognize that there are other beer styles of lagers and ales, including but not limited to, Pale lager, Witbier, Pilsner, Berliner Weisse, Maibock, Blonde Ale, Weissbier, American Pale Ale, India Pale Ale, Weisbier Saison, English Bitter, Biere de Garde, Double IPA, Dark lager, Vienna lager, Marzen, Amber ale, Brown ale, Bock, Dunkel, Dunkelweizen, Irish Dry Stout, Doppelbock, Porter, Stout, Foreign Stout, Baltic Porter, and Imperial Stout. The composition for creating this new styled beer may be comprised of the following style changing ingredients: an effective amount of one or more beer-style-changing characteristics or substances such as chocolate malt, dextrin malt, Nugget hops or malts, alpha amylase enzyme, and acid. The style changing ingredients can be in the form of a liquid, powder, semi-solid, or a solid. An effective amount, as used herein, is one or more style changing ingredients added to the base beer in order to create a target beer. When used, the one or more style changing ingredients are present in an effective amount. The effective amount of style changing ingredients used in the base beer is that amount that imparts the desired property or properties in the target beer. It is undesirable to include an amount of style changing ingredients in excess of the effective amount. One skilled in the art can use or include other types of carbohydrates.

Quantities of ingredients will vary depending on the batch size. Each batch size can be calculated based on the number of doses desired for a given batch. A standard dose for adding the style changing composition to a base beer beverage post-fermentation is 1 ounce. Therefore, if a batch size of 3 gallons is wanted, the following will calculate the number of one ounce doses for making three gallons.

$$y = ( \frac{3 gallons}{1 ounce} ) ( \frac{128 ounces}{1 gallon} ) = 384 ounces$$

An example method for creating a stout target beer from a light lager or pale ale base beer is as follows. Start with a base beer, such as a light lager or a pale ale, which has a particular beer style. The beer style characteristics for the base beer, a light lager or pale ale, can be found in Tables 3-7. The next step is to decide which target beer style is desired. In this example, the target beer style is a stout. The stout is analyzed for its characteristics such as long lasting to persistent head retention, tan to brown head color, thick and/or creamy head, clarity, medium-full to full-body, and low to medium-high carbonation, which can be found in Tables 3-7. Once the beer style characteristics are determined for both base and target beers, the plurality of beer style characteristics of the base beer are compared with the plurality of beer style characteristics of the target beer to obtain a plurality of difference beer style characteristics. Style changing ingredients or substances are then added to the base beer, post-fermentation, to provide at least a portion of the plurality of difference beer style characteristics so that the base beer, a light lager or a pale ale, have a taste and appearance similar to the target beer, a stout. The style changing ingredients, or substances include an effective amount of an effective amount of chocolate malt, dextrin malt, Nugget hops or malts, alpha amylase enzyme, and acid. To begin the process for making a batch of the style changing ingredients or substances, use a mill such as a gain mill, mill the malt to crack open the malt. Weigh out the flaked barley but keep it separate from the malt. Weigh out an effective amount of chocolate malt and dextrin malt. Using the gain mill, mill the malt to crack open the malt. The style changing ingredients are mashed, which is a process that is well-known in the art. Please see for example, “The Brewing of Beer: Mashing and Sparging” by Moritz, Edward R., Hazen Press, February 2011.

Put the mashing contents into a collecting bowl with a strainer, straining the grains out. Shake the strainer to ensure most of the liquid is collected. Discard the spent grains.

The product needs to run though a centrifuge to ensure smaller, unwanted particles are eliminated. Run the mixture through the centrifuge twice. This product is now called the wort.

Next, place the wort into a boil kettle. Bring the wort up to a boil and add in the first hop addition. Maintain this boil for about 40 minutes. After the 40 minutes of boiling, add in the second hop addition. After boiling for another 20 minutes, remove pot from heat. Strain the contents of the boil kettle through a strainer to get out the hops.

The product needs to run though a centrifuge again to ensure smaller, unwanted particles are eliminated.

Return the product back to the boil kettle. Bring the contents up to pasteurization temperature. Before packaging, the pH of the mixture must be determined. The pH must be below 4.3 in order for the mixture to be ready for packaging. If it is above 4.3, add acid in ⅛ teaspoon increments until desired pH is achieved. The product is now ready to be packaged. An acid blend has been used in this case. This blend contains malic and tartaric acid.

The amount of time to process this product is dependent on the batch size. The greater the batch size, the longer the process time will be. With equipment such as the steam-jacketed kettle, boiling is achieved on a 3 gallon batch in less than an hour. This product is then boiled for 5 minutes, leaving the total processing time to about 1 hour.

There are many benefits to a short processing time. This allows more batches to be pushed through production. This also benefits the cost side of the process. Shorter processing times amass to lower cost from energy utilization.

The product can be packaged in one ounce doses, for example. For example, packaging has been done using a home vacuum sealer and a straight sealer. Product is packaged cold. Other packaging possibilities may include: packaging the final product immediately after it is finished, putting the sealed packages into a water bath that reaches 185 degrees Fahrenheit, sterilizing packaging and product immediately before filling, or a combination of these. Canning, such as in glass jars, has also been used as a method of preservation and methods associated therewith are well-known in the art. Other types of packaging may include bottling in twelve ounce beer bottles. In a twelve ounce bottle, there are twelve doses of product available. Flavor stability of the product is seen weeks after bottling. Flavor and aroma of the new beer style can be stabilized by for example, the use of vacuum sealing. Further, other types of packing for the final composition of beer style changing ingredients or substances may also be packaged, for example, in pods. The style changing composition or substances, may also be packaged in bulk containers, such as kegs, barrels, totes, or other large types of containers. Other types of industry appropriate packaging for the final composition of beer style changing ingredients or substances may be used and is well-known in the art.

The final composition of style-changing ingredients or substances can now be added to the base beer, a light lager or a pale ale, post-fermentation, to provide at least a portion of the plurality of difference beer style characteristics so that the base beer has a taste and appearance similar to the target beer, a stout.

### Example 5

### Creating a Pale Ale from a Base Beer

The following is an example of a post-fermentation method and composition for creating a new beer style by changing the beer style of a base beer to create a target beer, such as a pale ale. As previously noted, there are two general categories of beer styles, lagers and ales. The base beer can be chosen from the types of beers previously mentioned herein. The base beer may be a light American lager, with the following characteristics no head retention, frothy head, white head, very clear, very light body, a carbonic mouthfeel, and high carbonation, or with characteristics as mentioned in Tables 3-7. Characteristics such as good head retention, white to off-white head color, moderately large head, clear to slightly hazy clarity, medium to medium-light body, and smooth finish for the targeted beer style, a pale ale, are desired.

The composition for creating this pale ale beer style may be comprised of the following style changing ingredients: an effective amount of final composition of beer style changing ingredients or substances such as crystal 20 L malt, dextrin malt, Cascade hops or malt, alpha amylase enzyme, grain alcohol, and acid. The style changing ingredients can be in the form of a liquid, powder, semi-solid, or a solid. An effective amount, as used herein, is one or more style changing ingredients or substances added to the base beer in order to create a target beer. When used, the one or more style changing ingredients are present in an effective amount. The effective amount of style changing ingredients used in the base beer is that amount that imparts the desired property or properties in the target beer. It is undesirable to include an amount of style changing ingredients in excess of the effective amount. One skilled in the art can use or include other types of carbohydrates.

Quantities of ingredients will vary depending on the batch size. Each batch size can be calculated based on the number of doses desired for a given batch. A standard dose for adding the style changing composition to a base beer beverage post-fermentation is 1 ounce. Therefore, if a batch size of 3 gallons is wanted, the following calculate the number of one ounce doses for making three gallons.

$$y = ( \frac{3 gallons}{1 ounce} ) ( \frac{128 ounces}{1 gallon} ) = 384 ounces$$

An example method for creating a pale ale style target beer from a base beer is as follows. Start with the base beer, which has a particular beer style. The beer style characteristics of various beer styles are listed in Tables 3-7. The next step is to decide which target beer style is desired. In this example, the target beer style is a pale ale. The pale ale is analyzed for its characteristics, which can be found in Tables 3-7. Once the beer style characteristics are determined for both the base and target beers, the plurality of beer style characteristics of the base beer are compared with the plurality of beer style characteristics for the target beer to obtain a plurality of difference beer styles. Style changing ingredients or substances are then added to the base beer, post-fermentation, to provide at least a portion of the plurality of difference beer style characteristics so that the base beer has a taste and appearance similar to the target beer, a pale ale.

The composition for the style changing ingredients includes an effective amount of crystal 20 L malt, dextrin malt, Cascade hops or malt, alpha amylase enzyme, and water. To begin the process for making a batch of the style changing ingredients or substances, the day prior to brewing the style changing ingredients, a mixture of an effective amount of grain alcohol and an effective amount of the hops needs to be made. This mixture is then allowed to sit for 3 days, shaking every 8 hours. The hops are strained from the grain alcohol and discarded.

Weigh out an effective amount of crystal malt and dextrin malt. Using a mill, such as a gain mill, mill the malt to crack open the malt. Mashing the composition is a process that is well-known in the art. Please see for example, “The Brewing of Beer: Mashing and Sparging” by Moritz, Edward R., Hazen Press, February 2011.

Put the mashing contents into a collecting bowl with a strainer, straining the grains out. Shake the strainer to ensure most of the liquid is collected. Discard the spent grains.

The product needs to run though a centrifuge to ensure smaller, unwanted particles are eliminated. Run the mixture through the centrifuge twice. The product is now called the wort.

Next, place the wort into a boil kettle. Bring the wort up to a boil and add in the first hop addition. Maintain this boil for 30 minutes. After the 30 minutes of boiling, add in the second hop addition. After boiling for another 30 minutes, remove pot from heat and add in the appropriate amount of grain alcohol and hops mixture. Strain the contents of the boil kettle through a strainer to get out the hops.

The product needs to run though a centrifuge again to ensure smaller, unwanted particles are eliminated.

Return the product back to the boil kettle. Bring the contents up to pasteurization temperature. Before packaging, the pH of the mixture must be determined. The pH must be below 4.3 in order for the mixture to be ready for packaging. If it is above 4.3, add acid in ⅛ teaspoon increments until desired pH is achieved. The product is now ready to be packaged. An acid blend has been used in this case. This blend contains malic and tartaric acid.

The amount of time to process this product is dependent on the batch size. The greater the batch size, the longer the process time will be. With equipment such as the steam-jacketed kettle, boiling is achieved on a 3 gallon batch in less than an hour. This product is then boiled for 5 minutes, leaving the total processing time to about 1 hour.

There are many benefits to a short processing time. This allows more batches to be pushed through production. This also benefits the cost side of the process. Shorter processing times amass to lower cost from energy utilization.

The product can be packaged in one ounce doses, for example. For example, packaging has been done using a home vacuum sealer and a straight sealer. Product is packaged cold. Other packaging possibilities may include: packaging the final product immediately after it is finished, putting the sealed packages into a water bath that reaches 185 degrees Fahrenheit, sterilizing packaging and product immediately before filling, or a combination of these.

Canning, such as in glass jars, has also been used as a method of preservation and methods associated therewith are well-known in the art. Other types of packaging may include bottling in twelve ounce beer bottles. In a twelve ounce bottle, there are twelve doses of product available. Flavor stability of the product is seen weeks after bottling. Flavor and aroma of the new beer style can be stabilized by for example, the use of vacuum sealing. Further, other types of packing for the final beer style changing composition or substances may also be packaged, for example, in pods. The beer style changing composition or substances, may also be packaged in bulk containers, such as kegs, barrels, totes, or other large types of containers. Other types of industry appropriate packaging for the final composition of beer style changing ingredients or substances may be used and is well-known in the art.

The final composition of style-changing ingredients or substances can now be added to the base beer, post-fermentation, to provide at least a portion of the plurality of difference beer style characteristics so that the base beer has a taste and appearance similar to the target beer, a pale ale.

### IV. Beer-Style-Changer Distribution Model

Another embodiment of the present invention includes an efficient distribution process for alcoholic beverages. Presently, in the process of distributing alcohol beverage, a three-tier system is currently being used, as shown in FIG. 1, a flow diagram of a current national distribution model. The three tiers are producers, distributors, and retailers. Producers must sell their product to wholesale distributors who then in turn sell to retailers. The retailers then sell the product to the consumer.

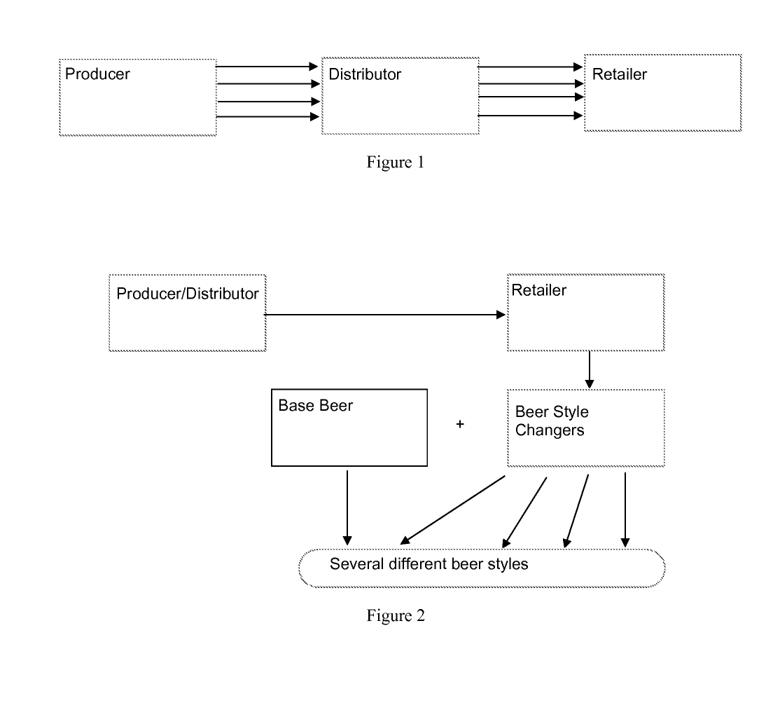

FIG. 2 shows an alternative national distribution system for multiple beer styles according to an embodiment of the invention. In this diagram, and in contrast to FIG. 1, the producer and distributor do not have to sell multiple styles of beer to the retailer. A base beer and multiple beer-style-changers (the final composition of beer style changing ingredients) can be sold to the retailer such that the retailer can offer consumers multiple styles of beer by buying initially only one type of beer. When viewing this model, the cost to ship beer across the country must also be considered. Since beer is made up of approximately 95% water, the cost of shipping is fairly high due to the weight of that water.

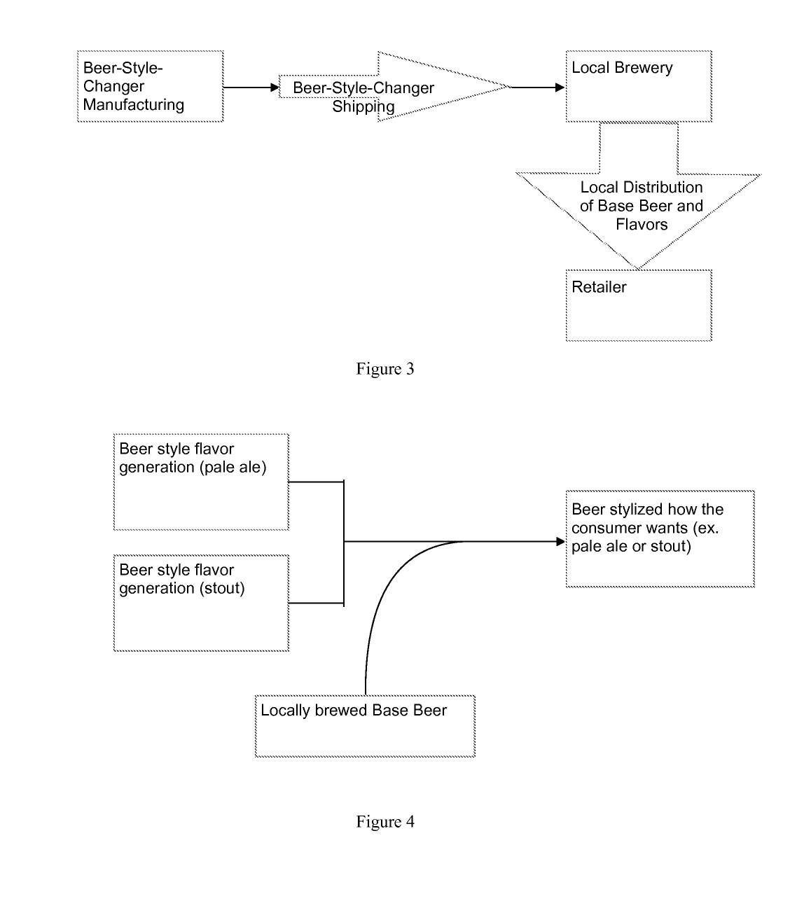

FIG. 3 shows an alternative local distribution system for multiple styles of beer according to an embodiment of the present invention. In FIG. 3, breweries, for example, can act as their own distributor in the local vicinity. Using this exception, contract breweries could be set up in local cities and distribute the alcohol beverages themselves, which would be a novel concept in two ways. This embodiment has two distinct advantages. First, if the contract breweries distribute the beverages themselves, this would eliminate the cost of selling through a distributor. Second, this model would eliminate the cost to ship a 95% water product across the country.

This local contract brewery would be able to produce beer, for example, and distribute the beer locally, eliminating the need to ship beer across the country. If the out of state distribution cost for a brewery is Cost X and the in-state, local distribution for a brewery is Cost Y, the two can be equated by Cost X−distributor fees=Cost Y. Though there is still a distribution cost for the local brewery, profit and fees can be managed to best suit the bottom line of the local brewery. This means, that it is beneficial to a local brewery to distribute the product themselves as much as possible.

In conjunction with the beer style changer product, a local contract brewery can be set up to brew a base beer, with limited attributes. The base beer can be distributed locally without the need to hire a wholesale distributor. This base beer can then be transformed into several different beer styles using the beer-style-changer product.

As shown in FIG. 3, in the local three-tier system with the style changers, only one type of beer, the base beer, needs to be distributed. When viewing this model, the cost to ship beer across the country must also be considered. Since beer is made up of approximately 95% water, the cost of shipping is fairly high due to the weight of that water. The beer-style-changer would allow a producer to capitalize on the opportunity to distribute locally by setting up a contract, local brewery and shipping only the beer-style-changer.

Beer-style-changer products are generated externally to the brewing process, and therefore, can be shipped and manufactured separately at a different location and are not subject to the standards laws of alcohol manufacturing, distribution and retail selling. Since only the beer-style-changers need to be shipped, the producer saves about 95% in the shipping costs, that is, the cost to ship water across the country.

The beer-style-changers can now be combined with a base beer that is brewed and distributed locally, allowing the producer to save additional costs for both distribution and shipping. This is greatly beneficial because while conventionally brewed beer takes weeks to brew, a new variety of beer-style-changer can take as little as a day or two to produce. This leads to a turnover rate for new beer styles, utilizing the beer-style-changer that is much quicker than what a conventional brewer can accomplish. The faster production rate, the cheaper cost of shipping, and the lower distribution fees lead to higher product margins, and/or lower consumer costs, and quicker beer delivery to the consumer.

FIG. 4 shows a flow diagram of the beer style changing process according to an embodiment of the present invention. To make a new style of beer, only a new beer-style-changer would have to be generated. This is then shipped to the local contract brewery where the beer-style-changer is combined with the locally-brewed base-beer and can be distributed locally. While the contract brewery is only brewing the Base Beer, the beer-style-changers are generated wherever it is convenient and at a much faster rate than generating a new beer. The single brew at the local brewery can be distributed and turned into any style available through the use of a beer-style-changer. The consumer can enjoy any style of locally brewed beer even though only the base beer is actually brewed locally.

What is claimed is:

1. A post-fermentation method for altering a base beer to taste like and have an appearance similar to a target beer comprising:
analyzing a base beer to obtain a plurality of base beer style characteristics;
analyzing a target beer to obtain a plurality of target beer style characteristics;
comparing said plurality of base beer style characteristics with said plurality of target beer style characteristics to obtain a plurality of difference beer style characteristics; and
adding substances to said base beer, post-fermentation, that provide at least a portion of said plurality of difference beer style characteristics so that said base beer has a taste and appearance similar to said target beer.

2. The method of claim 1, wherein said base beer style characteristics includes international bitterness units.

3. The method of claim 2, wherein said base beer style characteristics includes sweetness.

4. The method of claim 3, wherein said base beer style characteristics includes malt flavor.

5. The method of claim 4, wherein said base beer style characteristics includes clarity.

6. The method of claim 5, wherein said base beer style characteristics includes alcohol content.

7. The method of claim 6, wherein said base beer style characteristics includes turbidity.

8. The method of claim 7, wherein said base beer style characteristics includes body.

9. The method of claim 8, wherein said base beer style characteristics includes aroma.

10. The method of claim 9, wherein said base beer style characteristics includes crispness.

11. The method of claim 10, wherein said base beer style characteristics includes calories.

12. The method of claim 1, wherein said target beer style characteristics includes international bitterness units.

13. The method of claim 12, wherein said target beer style characteristics includes sweetness.

14. The method of claim 13, wherein said target beer style characteristics includes malt flavor.

15. The method of claim 14, wherein said target beer style characteristics includes clarity.

16. The method of claim 15, wherein said target beer style characteristics includes alcohol content.

17. The method of claim 16, wherein said target beer style characteristics includes turbidity.

18. The method of claim 17, wherein said target beer style characteristics includes body.

19. The method of claim 18, wherein said target beer style characteristics includes aroma.

20. The method of claim 19, wherein said target beer style characteristics includes crispness.

21. The method of claim 20, wherein said target beer style characteristics includes calories.

22. A method of producing a plurality of styles of beer comprising:
obtaining a base beer with a small number of beer style characteristics; and
altering said base beer to have a similar taste and similar appearance to a target beer by:
a. analyzing a base beer to obtain a plurality of base beer style characteristics;
b. analyzing a target beer to obtain a plurality of target beer style characteristics;
c. comparing said plurality of base beer style characteristics with said plurality of target beer style characteristics to obtain a plurality of difference beer style characteristics; and
d. adding substances to said base beer, post-fermentation, that provide at least a portion of said plurality of difference beer style characteristics so that said base beer has a taste and appearance similar to said target beer.

23. A target beer comprising a base beer that has been altered to taste similar to and have an appearance similar to a target beer, said base beer having a plurality of substances that have been added to said base beer, post-fermentation, so that said base beer has said taste and said appearance similar to said target beer, said substances selected to provide a plurality of difference beer style characteristics that are determined by analyzing said base beer to obtain a plurality of base beer characteristics, analyzing a target beer to obtain a plurality of target beer characteristics, and comparing said plurality of said base beer characteristics with said plurality of target beer characteristics to obtain said plurality of difference beer style characteristics.
